(19) United States
(12) Patent Application Publication
(10) Pub. No.: US 2003/0193147 A1
(43) Pub. Date: Oct. 16, 2003

(54) SPIRAL WOUND GASKET AND GRAPHITE FILLER MATERIAL FOR A SPIRAL WOUND GASKET

(76) Inventors: HIDETO HASHIGUCHI, SANDA-SHI (JP); TAKAHISA UEDA, SANDA-SHI (JP); TAKESHI MIYOSHI, SANDA-SHI (JP)

Correspondence Address: FELIX J D'AMBROSIO, JONES TULLAR AND COOPER, P O BOX 2266 EADS STATION, ARLINGTON, VA, 22202

(21) Appl. No.: 09/166,233

(22) Filed: Oct. 5, 1998

(51) Int. Cl. F16J 15/02

(52) U.S. Cl. 277/633

(57) ABSTRACT

The present invention relates to a filler material (1) for a spiral wound gasket, and to a spiral wound gasket (W) using the fillermaterial (1). The fillermaterial (1) and the spiral wound gasket (W) according to the invention can be applied to various pipe joints and a joint portions of fluid equipments for sealing fluid such as liquid and gaseous body. The filler material (1) of the invention is obtained by removing, by blast treatment, a high density portion on a front surface (2A) or a back surface (2B) of a tape-like expansive graphite tape (2) formed by integrally pressurizing expanded graphite particles. The spiral wound gasket (W) is obtained by overlapping the filler material (1) and a hoop material (5) made of metal band plate with each other and winding them in the form of a spiral. The spiral wound gasket (W) is superior in productivity, and in flexibility, bending property and pliability, and exhibit excellent sealing property even at a low surface pressure.

### BACKGROUND OF THE INVENTION

1. Field of the Invention

The present invention relates to a filler material for a spiral wound gasket applied to various pipe joints and a joint portions of fluid equipments for sealing fluid such as liquid including water and oil, and gaseous body including vapor and gas.

Further, the present invention relates to a spiral wound gasket formed using the above-mentioned filler material.

2. Description of the Prior art

The conventionally known typical spiral wound gasket comprises a hoop material made of metal band plate having corrugate cross section such as V-shape or W-shape, a filler material made of asbestos paper, which are overlapped with each other and wound in the form of a spiral.

However, in such a spiral wound gasket, the asbestos paper used as a filler material generates fine particles when it is handled, and it is pointed out that if people inhale the fine particles, it ruins health. For this reason, the asbestos paper is refrained from being used at present. As alternative filler material, there has been developed a spiral wound gasket using expansive graphite filler material using, as a filler material, expansive graphite tape of non-asbestos.

Further, in order to enhance the sealing property of the spiral wound gasket using the expansive graphite filler material, there have been proposed a gasket using auxiliary filler material comprising PTFE fiber (tetrafluoride polyethylene resin fiber) having graphite in addition to the expansive graphite filler material, and a gasket comprising the expansive graphite filler material and carbon fiber incorporated therein and extended along a longitudinal direction.

However, the conventional spiral wound gasket using the expansive graphite filler material has the following problems:

(1) Since a tensile strength of the expansive graphite tape is low, it is prone to be damaged when it is wound in the form of a spiral.

(2) Since an elongation of the expansive graphite tape is small and lacks a flexibility, the tape can not be deformed along a space shape formed between the metal band plate hoop materials, and a clearance is prone to be generated, and the tape is prone to be split if it is to be bent. Especially if the tape is combined with the hoop material having corrugate cross section, when they are wound in the form of a spiral, the vertex of the corrugate is split and a clearance is generated there, and for this reason, there is a possibility that a slight infiltration may be generated in the widthwise direction or winding direction of the spiral.

(3) The expansive graphite tape formed merely by pressurizing the expansive graphite particles have fine clearances therein, but its surface has a dense layer of expansive graphite particles at high density and high orientation. Therefore, it is difficult to impregnate or coat various weather stripping which are carried out when the asbestos paper is used. Especially, the surface of the expansive graphite tape has a water-repellent property under existence of the above-mentioned dense layer, leakage of water is inferior, and it is difficult to improve the sealing property by impregnating or coating the weather stripping of water-dispersion type, for example.

(4) A filler material in which PTFE-based auxiliary sealing member is also used, or carbon fiber is compounded is expensive as a material, and producing process therefor is complicated, if the PTFE-based auxiliary sealing member is used jointly, heat-resistance is lowered.

### SUMMARY OF THE INVENTION

The present invention has been accomplished in view of the above circumstances.

An object of the present invention is to provide a filler material for a spiral wound gasket in which flexibility, bending property and pliability are largely improved to enhance the productivity.

Another object of the invention is to provide a filler material for a spiral wound gasket in which a sealing property is remarkably enhanced even at a surface pressure generated under the condition that a fastening force is small.

Another object of the invention is to provide a spiral wound gasket using such a filler material.

To achieve the above objects, in a filler material for a spiral wound gasket according to the present invention, from a surface of at least a portion of the surface of an expansive graphite tape comprising integrally pressurized expanded graphite particles, a high density portion is removed. In this filler material, since the dense layer portion of high density is removed, flexibility is improved, flexible bending property is provided so that pliability is enhanced, and bending strength is also improved.

In the filler material of the invention, at least a portion of high density portion on the front or back surface of the expansive graphite tape may be removed along a longitudinal direction of the tape, thereby forming a projection which is continuous along the longitudinal direction of the tape. With this feature, the bending degree of the entire tape is improved in a degree. Further, since the projection which is continuous in the longitudinal direction of the tape is provided, when the hoop material having a corrugated cross section is used, density at the vertex of the corrugated shape can be increased, and it is possible to prevent a leakage in the winding direction when the spiral wound gasket is formed from being generated, and to further enhance the sealing property.

The spiral wound gasket according to the invention is formed by overlapping the above filler material and a hoop material made of metal band plate with each other and winding them in the form of a spiral.

Since this spiral wound gasket uses the filler material whose various characteristics are improved, when it is wound in the form of a spiral, the fillermaterial is not easily damaged and thus, the productivity of the gasket is improved. Furthermore, it is easy to deform the filler material along a space shape formed between the hoop materials, the filler is not easily split against the bending, and clearance is not generated, or the possibility of generation of the clearance can be reduced largely, and it is possible to remarkably enhance the sealing property of the spiral wound gasket as a whole. When the filler material has the projection, it is desirable that a ratio of height and width of the projection projecting from its opposite sides is 1:10.

Further, a shape of cross section of the metal band plate may be corrugated. In such a case, it is desirable that the front or back surface of the expansive graphite tape from which at least a portion of the high density portion is removed is contacted with a valley of the metal band plate. The spiral wound gasket can include an inner diameter d1=72.6 mm, an outer diameter d2=92.5 mm and a thickness t1=14.5 mm.

A weather stripping may be coated or impregnated in the expansive graphite tape. As the weather stripping, polyethylene glycol, PTFE, wax, silicon resin, rubber and the like is preferably used. If the weather stripping is coated or impregnated in the expansive graphite tape, it is possible to easily carry out the coating on the weather stripping, and occlude fine clearance existing in the expansive graphite tape, which is effective for improving the sealing property at a low surface pressure.

As described above, according to the filler material of the invention, various characteristics of the productivity and sealing property which are required when the expansive graphite filler material is used as a filler material for spiral would gasket instead of the asbestos can be remarkably improved by the extremely simple means, i.e., by removing the high density portion.

Further, according to the spiral wound gasket of the invention, since the filler material whose various characteristics are improved is used, not only the productivity, but also the sealing property can remarkably improved.

The above and other features and advantages of the invention will become more apparent from the following description of preferred embodiments.

### BRIEF DESCRIPTION OF THE DRAWINGS

FIG. 1 is a perspective sectional view of an essential portion of a filler material for a spiral wound gasket according to an embodiment 1 of the invention;

FIG. 2 is a perspective sectional view of an essential portion of a filler material for a spiral wound gasket according to an embodiment 2 of the invention;

FIG. 3 is a perspective sectional view of an essential portion of a filler material for a spiral wound gasket according to an embodiment 3 of the invention;

FIG. 4 is a perspective sectional view of an essential portion of a filler material for a spiral wound gasket according to an embodiment 4 of the invention;

FIG. 5 is a perspective sectional view of an essential portion of a fillermaterial for a spiral wound gasket according to a comparative example;

FIG. 6 is a half vertical section of the spiral wound gasket of the invention;

FIG. 7 is a diagram for explaining a test method for a normal-temperature gas seal;

FIG. 8 is a diagram for showing the result of the test method for the normal-temperature gas seal;

FIG. 9 is a diagram for explaining 90° bending test; and

FIG. 10 is a diagram for explaining a winding test.

### DETAILED DESCRIPTION OF THE PREFERRED EMBODIMENTS

Embodiments of the present invention will be explained in accordance with the drawings below.

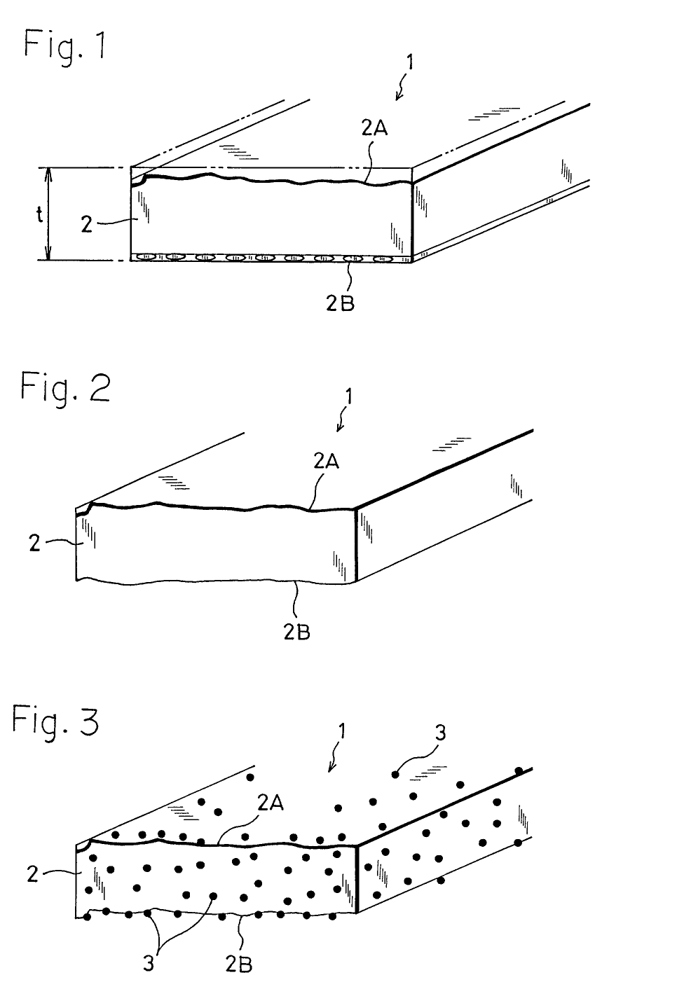

Each of filler materials 1 for a spiral wound gasket according to embodiments 1, 2, 3 and 4 shown in FIGS. 1, 2, 3 and 4, respectively, as well as according to a comparative example shown in FIG. 5 is formed into a tape-like expansive graphite tape 2 by integrally pressurizing expanded graphite particles. A thickness t of the expansive graphite tape 2 (thickness t is shown in FIG. 1, and omitted in FIGS. 2 to 5) is 0.38 mm. The expansive graphite tape 2 is subjected to the following treatments. The treatment for the front and back surfaces of the expansive graphite tape 2 conducted each of the embodiments and the comparative example will be explained below.

Embodiment 1:

As shown in FIG. 1, the expansive graphite tape 2 is uniformly subjected to a blast treatment such that the weight is reduced by 0.5% by weight, thereby removing high density dense layer portions. The reference numeral 2A denotes a front surface of the expansive graphite tape 2. High density dense layer portion on a back surface 2B of the expansive graphite tape 2 is left as it is.

Embodiment 2:

As shown in FIG. 2, the expansive graphite tape 2 is uniformly subjected to a blast treatment such that the weight is reduced by 1% by weight in total, thereby removing high density dense layer portions from both the front and back surfaces. The reference numerals 2A and 2B denote the front and back surfaces of the expansive graphite tape 2, respectively.

Embodiment 3:

As shown in FIG. 3, the expansive graphite tape 2 is uniformly subjected to a blast treatment such that the weight is reduced by 1% by weight in total, thereby removing high density dense layer portions from both the front and back surfaces. Then, 20% by weight of polyethylene glycol 3 as one example of weather stripping is impregnated to interiors and both the front and back surfaces 2A, 2B and clearances of inside thereof. Other than polyethylene glycol, PTFE, wax, silicon resin, rubber or the like may be used as the weather stripping.

Embodiment 4:

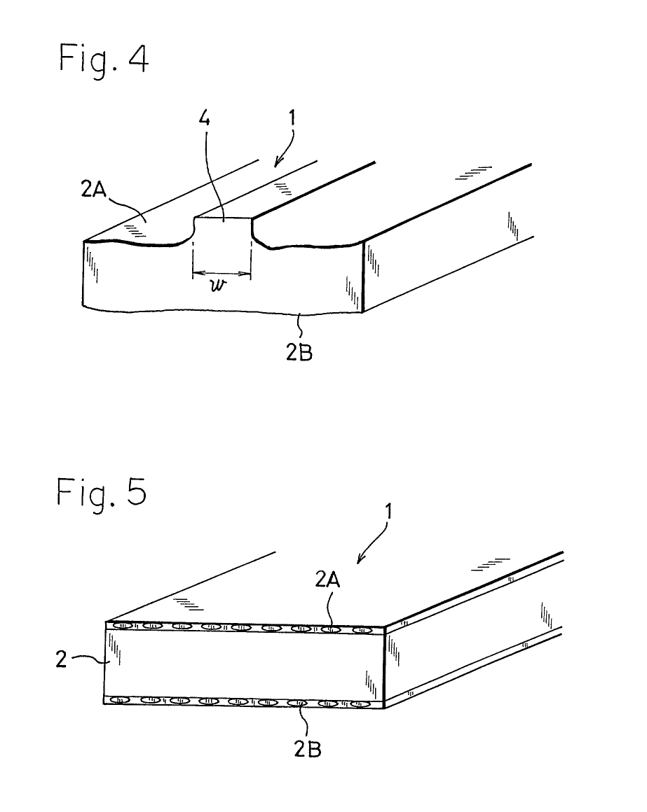

Using the filler material 1 for the spiral wound gasket in the embodiment 2, a projection 4 having a width w of 1 mm is continuously formed, in the longitudinal direction, on a widthwise central portion of a front surface 2A of the expansive graphite tape 2 from which the high density dense layer portions are removed as shown in FIG. 4. The projection 4 is higher than opposite sides by 0.1 mm.

### COMPARATIVE EXAMPLE

As shown in FIG. 5, the front surface 2A and back surface 2B of the expansive graphite tape 2 are subjected to no treatment, and high density dense layer portions exist.

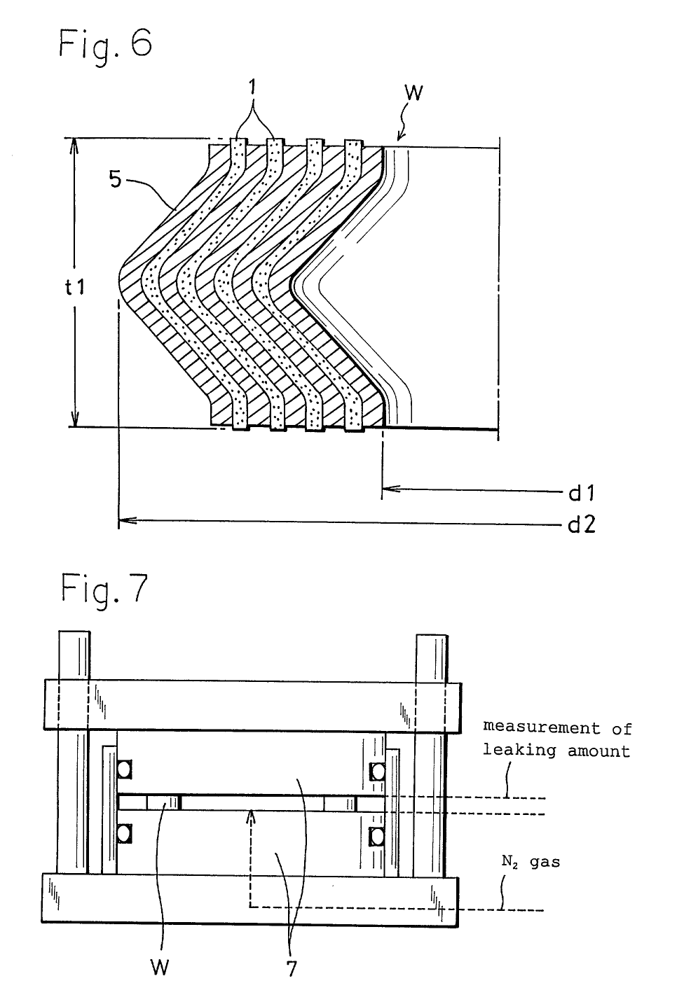

FIG. 6 shows a sectional structure of a spiral wound gasket W (sample). This spiral wound gasket W is formed by overlapping the filler materials 1 of the embodiments 1 to 4 and of the comparative example with metal band plate having a generally V-shaped cross section, more specifically, hoop material 5 of SUS 304, and winding in the form of spiral. The spiral wound gasket W has an inner diameter d1=72.6 mm, an outer diameter d2=92.5 mm and a thickness t1=14.5 mm. As to the embodiment 1, the spiral wound gasket W is wound such that the surface 2A from which high density dense layer portions are removed by the blast treatment is contacted with valley of the hoop material 5.

A normal temperature gas sealing test was conducted for each of the spiral wound gaskets W (samples) formed using the filler materials 1 and hoop materials 5 of the embodiments 1 to 4 and the comparative example.

As shown in FIG. 7, the normal temperature gas sealing test method is a method for repeating the following three steps: (1) a step of pressurizing each of the samples W by a pair of upper and lower pressurizing flanges 7, 7 at a predetermined surface pressure and keeping the pressurized state for three minutes; (2) applying N₂ gas and keeping such state for five minutes and then, measuring a leakage amount by a known soap film moving method; and (3) decompressing the N₂ gas to normal pressure and then raising the pressure to the next standard surface pressure.

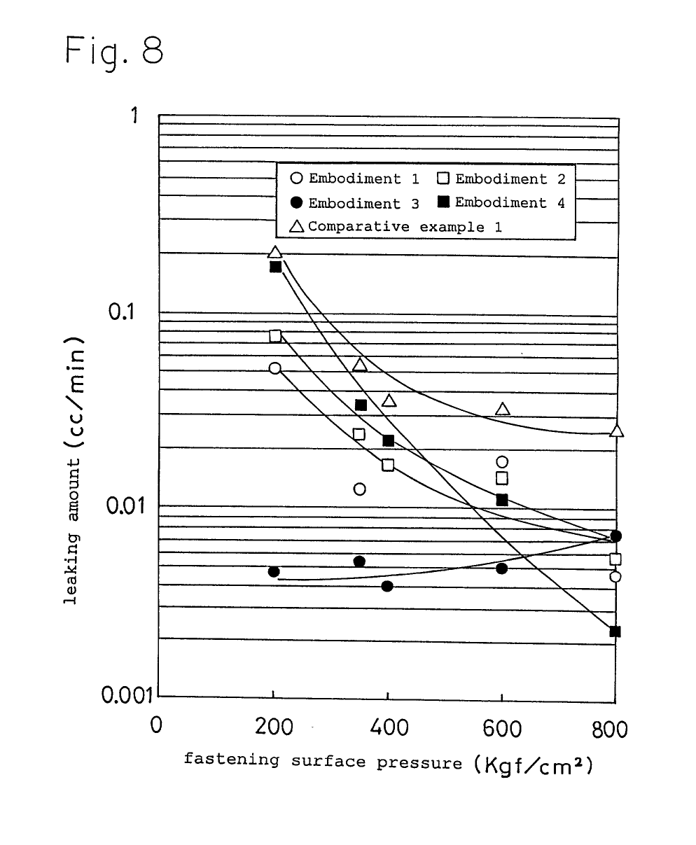

The results of the normal temperature gas sealing test are shown in FIG. 8. As apparent from this test results, although there is no difference in sealing characteristic in the spiral wound gasket using the filler material of the embodiment 1 and 2, the sealing property is superior to that of the comparative example. As to the spiral wound gasket using the filler material of the embodiment 3, although there is no remarkable change in sealing property at a surface pressure in the range of 200 to 800 kgf/cm², an excellent sealing property is exhibited at a low surface pressure of about 200 kgf/cm². As to the spiral wound gasket using the filler material of the embodiment 4, although there is no remarkable improvement in sealing property at a surface pressure of 200 kgf/cm², a remarkable sealing property of a fastening surface pressure is recognized at a surface pressure of 350 kgf/cm² or higher.

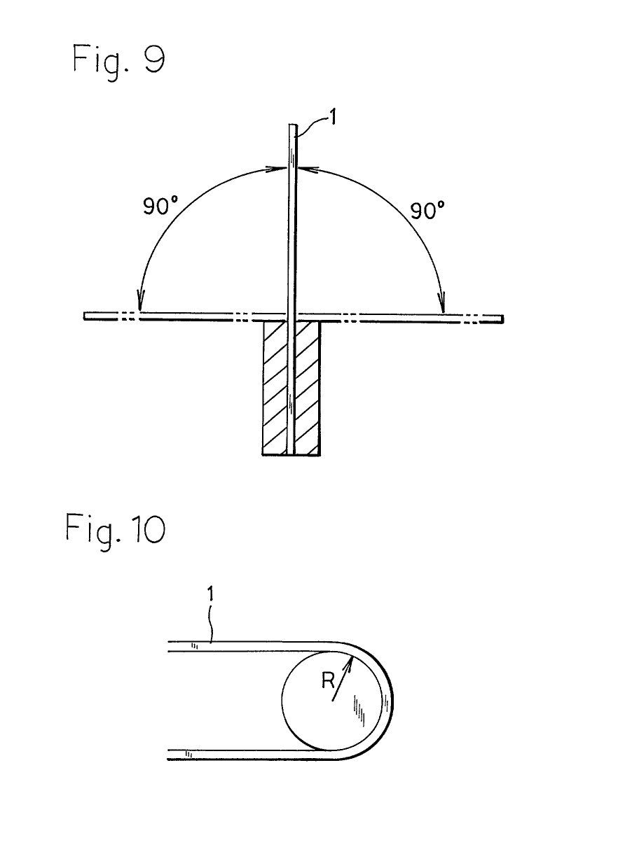

A 90° bending test was conducted for the filler material 1 of the embodiment 2 which is one of the materials of the invention, and conventional materials 1, 2, 3 and 4 shown in Table 1. As shown in FIG. 9, the 90° bending test is a test for alternately bending the filler material in opposite direction in thickness direction through 90°. The results of the 90° bending test are shown in Table 2. From Table 2, it can be seen that in the case of the conventional materials 1 to 4, the maximum number of bending times is 12.2 times, in the case of the present invention, the number of bending times is more than 1,000 times and thus, the latter is superior in flexibility.

TABLE 1

| | Conven- | Conven- | Conven- | Conven- | |
|---|---|---|---|---|---|
| | tional | tional | tional | tional | |
| | material | material | material | material | Embodiment |
| Sample | 1 | 2 | 3 | 4 | 2 |
| Raw | ramentum | ramentum | ramentum | ramentum | ramentum |
| material | | | | | |
| graphite | | | | | |
| Rate of | 120 | 140 | 140 | 180 | 180 |
| expansion | | | | | |
| (%) | | | | | |
| Number of | 6 | 6 | 8 | 8 | 8 |
| rolling | | | | | |
| (times) | | | | | |
| Seat | 1.0 | 1.0 | 1.0 | 1.0 | 1.0 |
| density | | | | | |
| (g/cm³) | | | | | |
| Thickness | 0.38 | 0.38 | 0.38 | 0.38 | 0.38 |
| (mm) | | | | | |
| Removal | Not | Not | Not | Not | 0.5% by |
| from | removed | removed | removed | removed | weight is |
| surface | | | | | removed |
| | | | | | from both |
| | | | | | surfaces |

TABLE 2

| | Conven- | Conven- | Conven- | Conven- | |
|---|---|---|---|---|---|
| | tional | tional | tional | tional | Embodi- |
| | material | material | material | material | ment |
| Sample | 1 | 2 | 3 | 4 | 2 |
| The possible | 1.6 | 3.0 | 5.3 | 12.2 | More than |
| bending | | | | | 1,000 |
| number | | | | | |
| (times) | | | | | |

Further, a winding test as shown in FIG. 10 was conducted for the filler material 1 of the embodiment 2 which is one of the materials of the invention, and conventional materials 3 and 4 shown in Table 1. The results are shown in Table 3. In the case of the conventional materials, the possible minimum winding radius was 4.5 mm, whereas, in the case of the material of the invention, the possible minimum winding radius R was extremely small as 1.5 mm, and the latter has excellent flexibility and flexible bending property.

TABLE 3

| | Conven- | Conven- | |
|---|---|---|---|
| | tional | tional | |
| Sample | material 3 | material 4 | Embodiment 2 |
| Possible winding | 4.5 | 6 | 1.5 |
| radius (mm) | | | |

The hoop material 5 of the spiral wound gasket W formed by using the filler material 1 of each of the embodiments 1 to 4 should not be limited to one having a V-shaped cross section described with reference to FIG. 6, and the hoop material 5 may be formed into a corrugate shape having a generally W-shaped or U-shaped cross section or into a flat plate shape.

The entire disclosure of Japanese Patent Application No. 9-116833 filed on May 7, 1997 including specification, claims, drawings and summary are incorporated herein be reference in its entirety.

What is claimed is:

1. A filler material for a spiral wound gasket, comprising an expansive graphite tape formed by integrally pressurizing expanded graphite particles, wherein
at least a portion of high density portion on a front or back surface of said expansive graphite tape is removed.

2. A filler material for a spiral wound gasket according to claim 1, wherein at least a portion of high density portion on the front or back surface of said expansive graphite tape is removed along a longitudinal direction of said tape, thereby forming a projection which is continuous along the longitudinal direction of said tape.

3. A spiral wound gasket formed by overlapping a filler material and another filler material with each other, wherein
a hoop material made of metal band plate and the filler material formed by removing at least a portion of high density portion on a front or back surface of an expansive graphite tape formed by integrally pressurizing expanded graphite particles are overlapped with each other and wound in the form of a spiral.

4. A spiral wound gasket formed by overlapping a filler material and another filler material with each other, wherein
a hoop material made of metal band plate and a filler material formed by removing at least a portion of high density portion on a front or back surface of an expansive graphite tape formed by integrally pressurizing expanded graphite particles, along a longitudinal direction of the tape so as to form a projection which is continuous in the longitudinal direction of the tape are overlapped with each other and wound in the form of a spiral.

5. A spiral wound gasket according to claim 3, wherein a weather stripping is coated or impregnated in said expansive graphite tape.

6. A spiral wound gasket according to claim 4, wherein a weather stripping is coated or impregnated in said expansive graphite tape.

7. A spiral wound gasket according to claim 5, wherein said weather stripping is selected from a group consisting of polyethylene glycol, PTFE, wax, silicon resin and rubber.

8. A spiral wound gasket according to claim 6, wherein said weather stripping is selected from a group consisting of polyethylene glycol, PTFE, wax, silicon resin and rubber.

9. A spiral wound gasket according to claim 4, wherein a ratio of height and width of said projection projecting from its opposite sides is 1:10.

10. A spiral wound gasket according to claim 3, wherein a shape of cross section of said metal band plate is corrugated.

11. A spiral wound gasket according to claim 4, wherein a shape of cross section of said metal band plate is corrugated.

12. A spiral wound gasket according to claim 3, wherein said front or back surface of said expansive graphite tape from which at least a portion of said high density portion is removed is contacted with a valley of said metal band plate.

13. A spiral wound gasket according to claim 4, wherein said front or back surface of said expansive graphite tape from which at least a portion of said high density portion is removed is contacted with a valley of said metal band plate.

14. A spiral wound gasket according to claim 3, wherein said gasket includes an inner diameter d1=72.6 mm, an outer diameter d2=92.5 mm and a thickness t1=14.5 mm.

15. A spiral wound gasket according to claim 4, wherein said gasket includes an inner diameter d1=72.6 mm, an outer diameter d2=92.5 mm and a thickness t1=14.5 mm.
